(19) United States
(12) Patent Application Publication
(10) Pub. No.: US 2006/0268665 A1
(43) Pub. Date: Nov. 30, 2006

(54) Method and apparatus for setting RTC time of digital broadcast receiver using time information contained in transport stream

(75) Inventors: Jung-min Kang, Seoul (KR); Soo-kang Bae, Seongnam-si (KR); Jin-yong Ahn, Suwon-si (KR); Du-il Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/441,080

(22) Filed: May 26, 2006

Related U.S. Application Data
(60) Provisional application No. 60/685,412, filed on May 31, 2005.

(30) Foreign Application Priority Data
Jun. 17, 2005 (KR) 10-2005-0052546

(51) Int. Cl. G04C 11/02

(52) U.S. Cl. 368/47

(57) ABSTRACT

Provided are a method and apparatus for setting the time of a real-time clock included in a digital broadcast receiver. Since the digital broadcast receiver sets the time of the real-time clock included therein, based on time information contained in a received transport stream, it is possible to synchronize the time of the real-time clock with a reference time based on the time information contained in broadcast data transmitted by a broadcast transmitter. Accordingly, it is possible to minimize time-related errors during the execution of a time-dependent application program such as a scheduled-recording program.

### CROSS-REFERENCE TO RELATED PATENT APPLICATIONS

This application claims priority of U.S. Provisional Application No. 60/685,412, filed on May 31, 2005, in the US PTO, and Korean Patent Application No. 10-2005-0052546, filed on Jun. 17, 2005, the disclosures of which are incorporated herein in their entirety by reference.

### BACKGROUND OF THE INVENTION

1. Field of the Invention

The present invention relates to a digital broadcast receiver, and more particularly, to a method and apparatus for setting the time of a real-time clock (RTC) included in a digital broadcast receiver.

2. Description of the Related Art

Digital broadcasting technology, which provides high-definition TV (HDTV) services or digital multimedia broadcast (DMB) services, has many advantages over existing analog television (TV) broadcasting technology in that it improves audio/video (AV) quality and allows mobility. Therefore, a lot of research has been conducted into the development and commercial use of digital broadcasting. In general, a real-time clock (RTC) is included as a clock in fixed or mobile devices capable of receiving digital broadcasting, and therefore, time-dependent operations are performed in a digital broadcast receiver, based on the time of the RTC.

However, if the time of the RTC is incorrect, errors may occur during the execution of time-dependent operations. For instance, if a user sets a specific broadcast to be recorded at a specific instant of time, the user cannot record the broadcast at the specific instant of time if the broadcast is transmitted from a broadcasting station at a different time from the time of the RTC.

### SUMMARY OF THE INVENTION

The present invention provides a method and apparatus for setting the time of a real-time clock (RTC) of a digital broadcast receiver using time information contained in a transport frame for digital broadcasting.

According to an aspect of the present invention, there is provided a method of setting time in a digital broadcast receiver, the method comprising receiving broadcast data containing time information; extracting the time information from the broadcast data; and setting a real-time clock time of the digital broadcast receiver based on the extracted time information.

A broadcast transmitter may be requested to provide the broadcast data containing the time information when the real-time clock time is not set for a predetermined amount of time.

According to another aspect of the present invention, there is provided a computer readable medium storing a program for executing a method of correcting the time of an RTC of a digital broadcast receiver based on time information contained in a transport frame.

According to another aspect of the present invention, there is provided a digital broadcast receiver which comprises a real-time clock, the receiver comprising an information extractor extracting time information from received broadcast data; and a time setter setting a time of the real-time clock based on the extracted time information.

### BRIEF DESCRIPTION OF THE DRAWINGS

The above and other aspects and advantages of the present invention will become more apparent by describing in detail exemplary, non-limiting embodiments thereof with reference to the attached drawings in which:

FIG. 1 is a schematic block diagram for illustrating a process of transmitting and receiving a digital broadcast;

FIG. 2 is a flowchart illustrating a method of setting the time of a real-time clock (RTC) in a digital broadcast receiver, according to a non-limiting embodiment of the present invention;

FIG. 3 is a flowchart illustrating a method of setting the time of a real-time clock (RTC) before a scheduled application program operates, according to a non-limiting embodiment of the present invention; and

FIG. 4 is a block diagram of a digital broadcast receiver according to a non-limiting embodiment of the present invention.

### DETAILED DESCRIPTION OF THE INVENTION

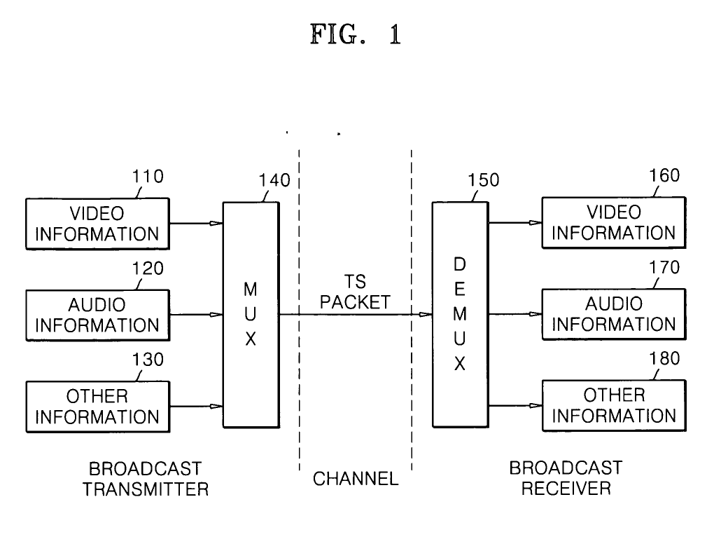

FIG. 1 is a schematic block diagram for illustrating a process of transmitting and receiving a digital broadcast. In general, referring to FIG. 1, in digital broadcasting, video information 110, audio information 120, and other information 130 that specifies channel numbers, reproduction time, etc., are multiplexed into a packet, which is a transport stream (TS), by a multiplexer 140, and the packet is transmitted to a digital broadcast receiver via a channel. Here, the TS is obtained by multiplexing several packets, which are comprised of a video bit stream and an audio bit stream, into a bit stream. With use of the TS, it is possible to multiplex a plurality of programs into a bit stream. The digital broadcast receiver receives the TS, extracts video information 160, audio information 170, and other information 180 from the TS by a demultiplexer 150, decodes them, and provides a user with the decoded result. As described above, the other information 130 may include various types of information according to the digital broadcast standard. In particular, according to an embodiment of the present invention, information regarding time when a broadcast is transmitted must be included in the other information 130 so that the information regarding the time is extracted from the TS to set the time of a real-time clock (RTC).

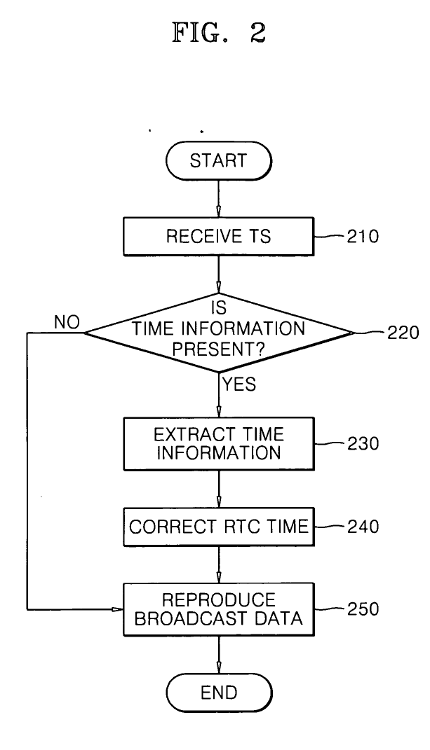

FIG. 2 is a flowchart illustrating a method of setting the time of an RTC in a digital broadcast receiver, according to a non-limiting embodiment of the present invention. First, the digital broadcast receiver receives a TS from an apparatus that transmits a digital broadcast (hereinafter referred to as a “transmitter”) via a wireless channel (210), and determines whether the received TS contains time information (220). Time information may not be contained in the TS according to the digital broadcast standard. If time information is not contained in the TS, a received broadcast is reproduced (250). If time information is contained in the TS, the time information is extracted from the TS (230), the time of the RTC is corrected based on the extracted time information (240), and the received broadcast is reproduced (250). Accordingly, in the above non-limiting embodiment of the present invention, the digital broadcast receiver is capable of synchronizing the time of the RTC included therein with a reference time based on the time information contained in the TS transmitted by the transmitter.

It is crucial that the digital broadcast receiver sets the time of the RTC based on the time information contained in the TS transmitted by the transmitter especially when the digital broadcast receiver needs to execute an application program for scheduled recording at a specific instant of time. This case will now be described in greater detail.

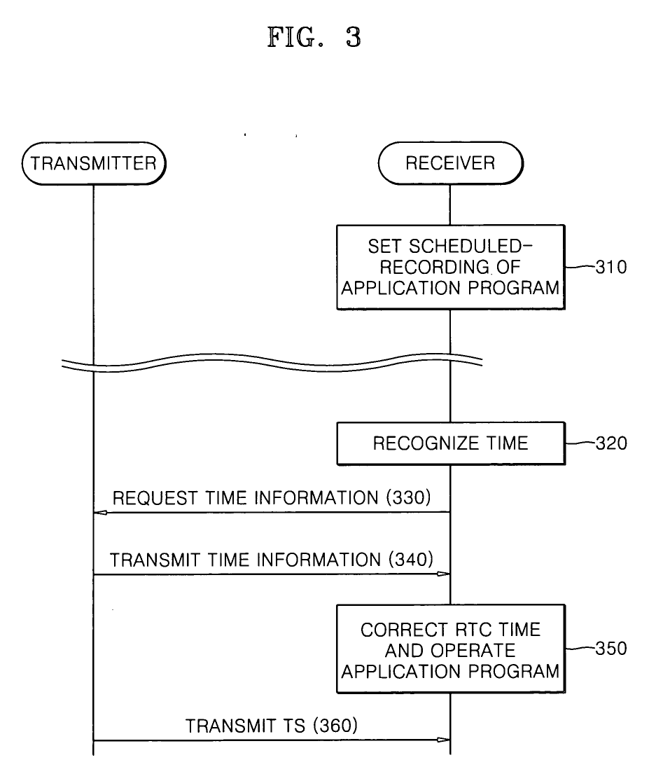

FIG. 3 is a flowchart illustrating a method of setting the time of a real-time clock (RTC) before an application program, which is scheduled to operate at a specific instant of time, operates, according to a non-limiting embodiment of the present invention. In the present embodiment, a scheduled-recording program will be instanced.

First, a user sets a scheduled recording by selecting a specific time and a specific channel, using a scheduled-recording program stored in a digital broadcast receiver (310). Then, when recognizing that the specific time is approaching after a predetermined amount of time (320), the digital broadcast receiver requests a transmitter to provide time information (330). Since the digital broadcast receiver determines whether it is the specific time based on the time of the RTC, the digital broadcast receiver requests the time information to set the time of the RTC before the specific time set in the RTC, considering the difference between the time of the RTC and the time information transmitted from the transmitter. Then, as per the request, the transmitter transmits a TS containing the time information to the digital broadcast receiver (340). Here, the TS is needed to correct the time of the RTC, and thus may not contain video or audio broadcast data. When receiving the TS containing the time information from the transmitter, the digital broadcast receiver extracts the time information from the TS and corrects the time of the RTC based on the extracted time information (350). Of course, when there is no difference between the time of the RTC and a reference time based on the time information, the time of the RTC need not be amended. Also, in operation 350, the digital broadcast receiver executes the scheduled-recording program at the specific time with reference to the time of the RTC synchronized with the reference time, receives a TS of a desired broadcast, and records the broadcast.

In the present embodiment, the digital broadcast receiver requests the transmitter to provide time information a predetermined amount of time before the specific time, and updates the time of the RTC based on the provided time information. However, in general, since various TSs, including a TS containing time information, are transmitted via many channels, the digital broadcast receiver may be set to detect a channel which carries the TS containing the time information from among the TSs at a predetermined instant of time without requesting the transmitter to provide the time information.

Also, without respect to a time-dependent application program in the present embodiment, the digital broadcast receiver may periodically receive a TS containing time information to correct the time of the RTC, thereby maintaining a minimum difference between the time of the RTC and a reference time based on the time information. However, this is possible when the transmitter periodically transmits a TS containing time information.

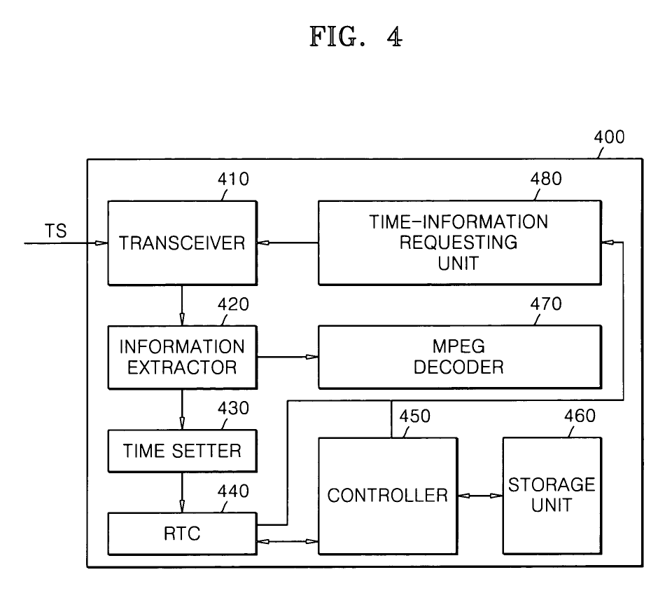

FIG. 4 is a block diagram of a digital broadcast receiver 400 according to a non-limiting embodiment of the present invention. Referring to FIG. 4, the digital broadcast receiver 400 includes a transceiver 410, an information extractor 420, a time setter 430, a RTC 440, a controller 450, a storage unit 460, an MPEG decoder 470, and a time-information requesting unit 480. For the complete operation of the digital broadcast receiver 400, additional constituent elements are further included therein, but are not included in the block diagram of FIG. 4 in order to clarify the claimed gist of the present invention.

The transceiver 410 transmits or receives a digital broadcast signal, i.e., a TS, and the information extractor 420 extracts time information and broadcast data from the TS received from the transceiver 410. The MPEG decoder 470 decodes audio/video data extracted by the information extractor 420 and transmits the decoding result to a user via an output unit (not shown). The time setter 430 corrects the time of the RTC 440 based on the time information extracted by the information extractor 420. The time-information requesting unit 480 requests a transmitter (not shown) to provide a TS containing time information via the transceiver 410, when the time of the RTC 440 has not been corrected for a predetermined amount of time or when the time of the RTC 440 needs to be corrected. The storage unit 460 stores various application programs. In the case of a time-dependent application program, such as a scheduled-recording program, which is operated by the controller 450 based on the RTC 440, the controller 450 checks the time of the RTC 440, and controls the time-information requesting unit 480 to request the transmitter to provide time information for correcting the time of the RTC 440 a predetermined amount of time before a specific time set by the user.

The above non-limiting embodiments of the present invention may be embodied as computer readable programs, and performed in a general digital computer that can execute the programs, using a computer readable medium.

The computer readable medium may be any recording apparatus capable of storing data that is read by a computer system, e.g., a magnetic recording medium (a ROM, a RAM, a floppy disk, a hard disc, etc.), an optical recording medium (a CD-ROM, a DVD, etc.), and a carrier wave that transmits data via the Internet, for example.

According to the present invention, a digital broadcast receiver sets the time of a RTC included therein, based on time information contained in a received TS. Accordingly, it is possible to synchronize the time of the RTC in the digital broadcast receiver with a reference time based on the time information contained in broadcast data transmitted by a broadcast transmitter, and minimize time-related errors during the execution of a time-dependent application program such as a scheduled-recording program,. Also, the digital broadcast receiver may periodically receive a TS containing time information to correct the time of the RTC based on the time information, thereby maintaining a minimum difference between the time of the RTC and the time information received from the transmitter.

While this invention has been particularly shown and described with reference to exemplary, non-limiting embodiments thereof, it will be understood by those skilled in the art that various changes in form and details may be made therein without departing from the spirit and scope of the invention as defined by the appended claims.

What is claimed is:

1. A method of setting time in a digital broadcast receiver, comprising:
requesting a time information to a broadcast system;
receiving broadcast data containing time information;
extracting the time information from the broadcast data; and
setting a time of the digital broadcast receiver based on the extracted time information.

2. The method of claim 1, wherein the digital broadcast receiver requests the time information periodically.

3. The method of claim 1, wherein the digital broadcast receiver requests the time information when the time of the digital broadcast receiver is not set for a predetermined amount of time.

4. The method of claim 1, further comprising operating an application program based on the time information.

5. The method of claim 4, wherein the requesting of the broadcast data is made a predetermined amount of time before a specific instant of time when a predetermined application program is scheduled to operate in the digital broadcast receiver.

6. A method of setting time in a digital broadcast receiver, comprising:
detecting a channel which carries broadcast data containing a time information;
receiving broadcast data containing the time information from the detected channel;
extracting the time information from the broadcast data; and
setting a time of the digital broadcast receiver based on the extracted time information.

7. The method of claim 6, further comprising requesting a time information to the broadcast transmitter.

8. The method of claim 6, further comprising operating a predetermined application program on the time information.

9. The method of claim 8, wherein the requesting of the broadcast data is made a predetermined amount of time before a specific instant of time when a predetermined application program is scheduled to operate in the digital broadcast receiver.

10. A computer readable medium having embodied thereon a program for causing a computer to execute a method of setting time of a broadcast receiver, the method comprising:
requesting a time information to a broadcast system;
receiving broadcast data containing the time information;
extracting the time information from the broadcast data; and
setting a time of the digital broadcast receiver based on the extracted time information.

11. A computer readable medium having embodied thereon a program for causing a computer to execute the method of setting time of a digital broadcast receiver, the method comprising:
detecting a channel which carries broadcast data containing a time information;
receiving broadcast data containing the time information from the detected channel;
extracting the time information from the broadcast data; and
setting a time of the broadcast receiver based on the extracted time information.

12. A digital broadcast receiver, comprising:
a time information requesting unit which sends a request message which request a time information;
a transceiver which receives a broadcast data containing the time information;
a real-time clock;
an information extractor operative to extract time information from received broadcast data; and
a time setter operative to set a time of the real-time clock based on the extracted time information.

13. The digital broadcast receiver of claim 12, wherein the time information requesting unit sends the request message periodically.

14. The digital broadcast receiver of claim 12, wherein the time information requesting unit sends the request message when the time of the digital broadcast receiver is not set for a predetermined amount of time.

15. The digital broadcast receiver of claim 14, further comprising a controller which operates an application program based on the time information.

16. The digital broadcast receiver of claim 15, wherein the time information requesting unit sends the request message a predetermined amount of time before a specific time when a predetermined application program is scheduled to operate.

17. A digital broadcast receiver, comprising:
a controller which detects a channel which carries broadcast data containing a time information and tunes to the channel;
a transceiver which receives a broadcast data containing the time information via the detected channel;
a real-time clock;
an information extractor operative to extract the time information from received broadcast data; and
a time setter operative to set a time of the real-time clock based on the extracted time information.

18. The digital broadcast receiver of claim 17, further comprising:
time information requesting unit which requests a time information to the broadcast transmitter.

19. The digital broadcast receiver of claim 17, wherein the controller operates a predetermined application program based on the time information.

20. The digital broadcast receiver of claim 19, wherein the requesting of the broadcast data is made a predetermined amount of time before a specific instant of time when a predetermined application program is scheduled to operate in the digital broadcast receiver.
